(19) United States
(12) Patent Application Publication
(10) Pub. No.: US 2003/0135397 A1
(43) Pub. Date: Jul. 17, 2003

(54) Medical billing system to prevent fraud

(76) Inventors: George M. Halow, El Paso, TX (US); Louis E. Zuniga, El Paso, TX (US)

Correspondence Address: Mitchell B. Wasson, Esq., HOFFMAN, WASSON & GITLER, PC, Suite 522, 2361 Jefferson Davis Highway, Arlington, VA, 22202, US

(21) Appl. No.: 10/042,236

(22) Filed: Jan. 11, 2002

(51) Int. Cl. G06F 17/60

(52) U.S. Cl. 705/4

(57) ABSTRACT

A system and method of determining and preventing fraud in the posting of medical insurance claims in which a clearing house is established for receiving information transmitted from a plurality of providers administering treatment covered by various insurance plans. For example, the clearing house would monitor the information provided by each of the providers to determine whether the providers submitted multiple claims for a particular period of time. The clearing house would also determine whether other inappropriate claims were made by the providers. If the clearing house determines that the treatments were proper, the providers would be paid by the clearing house in a timely manner.

### BACKGROUND OF THE INVENTION

1. Field of the Invention

The present invention is directed to a system and method of analyzing medical billing information for the purpose of preventing fraud, including multiple billing from a health care provider for a specified single time period.

2. Description of the Prior Art

It will come as no surprise to most individuals that the cost of health care in recent years has increased at a much greater rate than that of inflation. These individuals realize that the lack of adequate health care benefits could cause a massive outlay of money if that individual or a member of the individual's family were diagnosed with a very serious illness requiring a long stay in a hospital, nursing home or other health care facility. Similarly, if that individual or a member of the individual's family were involved in an accident, also requiring a long stay in a medical facility or would require extensive medical procedures, a drain on the family's resources would be created, even to the extent of requiring a personal bankruptcy. Therefore, to protect an individual or the individual's family from such financial hardship, the acquisition of adequate medical insurance sometimes requires an individual to make various decisions, such as employment, based upon the type and extent of insurance provided by various employers.

While the high cost of health care often results from new and remarkable advances in medical technology for diagnosing and treating various ailments and medical conditions, unfortunately, some of the increase in medical costs can be attributed to medical fraud. This medical fraud could include situations in which various medical personnel are conducting treatments not required from a particular diagnosis or never authorized by various insurance companies, including workman's compensation. Additionally, this fraud results from various medical personnel billing for multiple procedures during a particular time period. Due to the vast amounts of paperwork necessitated by various billing procedures, it is often very difficult to detect such medical fraud. The cost of this medical fraud is often passed on to the public in the form of higher premiums paid to private insurance companies.

Another problem in the health care industry occurs when various medical facilities, such as doctors' offices and clinics, are not associated with various private insurance companies or plans. If the particular medical facility is not part of a plan, individuals would not seek health care from these facilities since they would not be covered by their medical insurance plan. One reason that a medical facility would not be a participant in a certain medical plan resulted from prior dealings with that plan, including an exhaustive bureaucracy structure and a large delay in being reimbursed from the insurance company.

The existence of potential for medical fraud has been well-known for many years. Consequently, various systems and methods have been developed to endeavor to eliminate, or at least limit, the possibility of medical personnel defrauding the various insurance companies, as well as state and federal governments. A number of U.S. patents have issued directed to this problem. For example, U.S. Pat. No. 6,253,186, issued to Pendleton, Jr., describes a method and apparatus for detecting potentially fraudulent suppliers or providers of medical goods or services. A neural network is used, including software, for determining the existence of fraud after medical billing information is analyzed. A storage device includes a claims data file for storing information relating to a plurality of claims submitted for payment by a selected supplier or provider. The storage device may also include a statistics file for storing statistical information relating to a selected supplier or provider and a program for producing a statistical screening file from data contained in the neural network database and the statistics file. Although the patent to Pendleton, Jr. describes a method and apparatus for analyzing a supplier or provider to determine fraud, it does not analyze whether a particular medical provider has claimed to perform a plurality of tasks during a single time period.

U.S. Pat. No. 5,253,164, issued to Holloway et al, illustrates a system and method for detecting fraudulent medical claims via the examination of service codes. Generally, a user will enter into a computer system a description of the medical claims for which reimbursement or payment is requested, or the codes associated with such claims, or both. A history database, as well as a knowledge base interpreter, and a knowledge base are provided to determine whether fraudulent claims are being made. However, similar to the patent to Pendleton, Jr., the patent to Holloway et al does not focus on the issue of whether a single provider is claiming to have conducted different procedures at the same time.

U.S. Pat. No. 5,933,809, issued to Hunt et al, illustrates a computer software and processing medical billing record information system consisting of hospital or individual doctor medicare billing records. The software contains at least one set of instructions for receiving, converting, sorting and storing input information from the pre-existing medical billing records into a form suitable for processing. It is noted that the patent to Hunt et al generally is directed to a situation to identify potential medicare “72-hour billing rule” violations.

U.S. Pat. No. 5,235,702, issued to Miller, shows an automated posting of medical insurance claims system including a scanner and optical character recognition technology combined with software for verifying the medical records. Although FIG. 3 indicates in box 66 that a report is generated showing, among other things, the existence of duplicate claims, a reading of this patent would indicate that these duplicate claims are directed to one individual attempting to claim, and to be reimbursed for, receiving a treatment multiple times. This patent is not directed to a system in which one or more insurance companies, including workman's compensation, medicare and medicaid are asked to pay a provider for performing procedures for various patients during a single time period.

U.S. Pat. No. 4,987,538, issued to Johnson et al, details the automated processing of provider billings used for workman's compensation claims. This system includes rules provided in a computer's memory to examine specific billing documents. However, similar to the patents described hereinabove, this patent does not describe a system or method of insuring that a single provider does not bill for multiple procedure during a specified time period.

U.S. Pat. No. 5,930,759, issued to Moore et al, shows a method and system for processing health care electronic data transmissions including utilizing a network connected to a claims clearing house unit. This patent generally relates to a system or network for preparing and processing health care data transactions, such as dental or medical insurance claims and is not directed to a system similar to the system described in the present patent application.

### SUMMARY OF THE INVENTION

The deficiencies of the prior art are addressed by the present invention which is directed to a system and method of endeavoring to eliminate, or at least limit, fraud due to improper or deceptive medical claims procedures being submitted to various private or public insurers for collection by various medical providers. Although the present invention was designed as a system and method for processing claims generated by physical therapists, it is noted that this system and method can be accommodated to include all types of medical and dental personnel including doctors, nurses, chiropractors, physical therapists, occupational therapists, dentists, dental hygienists, as well as various technicians performing a range of medical and dental procedures.

Information relating to the time a medical or similar procedure was conducted, as well as specifying the individual conducting such a procedure, would be entered in a system which would also include a diagnostic code, as well as a treatment code. This information would be transmitted to a clearing house, either at the time the treatment was to be performed, or at a later time, such as the end of a business day. Both the provider location, as well as the clearing house, would contain software for analyzing this data. The software would insure that a single medical practitioner has appropriately billed an insurance company, including, but not limited to, insuring that the practitioner has not billed for multiple procedures at the same time. This software would also monitor the billing information to insure that a certain procedure was consistent with a diagnosis or treatment plan based upon entered procedure codes and diagnosis codes. This system would also monitor the procedure codes to determine that two or more procedure codes for a single patient are not mutually exclusive. If the system determines that proper billing procedures have been followed, the medical provider would be promptly paid for their services.

It is therefore an object of the present invention to develop a system and method to detect fraudulent medical claims and to prevent the payment of such fraudulent medical claims.

Another object of the present invention is to insure that a particular medical personnel is not billing for more than one procedure provided during a single period of time.

Yet another object of the present invention is to provide a system in which properly submitted claims are paid to a provider in a timely manner.

A further object of the present invention is to develop a system and method for insuring that a proper claim is made with regard to a particular procedure associated with a diagnosis or treatment.

Yet another object of the present invention is to develop a system and method for insuring that mutually exclusive procedures are not billed for a particular patient.

A further object of the present invention is to develop a system, including a clearing house, wherein a plurality of medical providers and a plurality of public and private insurers, provide information to prevent the perpetuation of fraudulent or unethical medical billing practices.

Still further advantages of the present invention will become apparent to those of ordinary skill in the art upon reading and understand the following detailed description.

### BRIEF DESCRIPTION OF THE DRAWINGS

A number of embodiments of the present invention will now be described with reference to the accompanying drawings, in which:

FIG. 1 is a block diagram showing the salient portions of the system of the present invention; and

FIG. 2 is a flow diagram illustrating the salient portions of the method of the present invention.

### DETAILED DESCRIPTION OF THE PREFERRED EMBODIMENTS

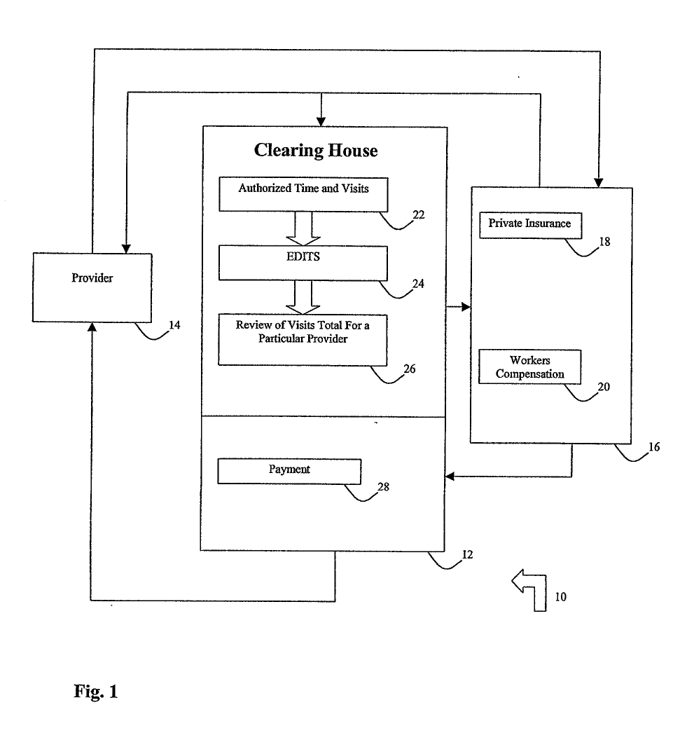

The system of the present invention 10 is illustrated in FIG. 1. A clearing house 12 is established to process bills generated by a number of medical practitioners directed to a number of private and public insurance entities. This system would verify and pay the plurality of practitioners or providers for the performance of various medical or dental procedures. One such provider is shown at 14. The purpose of the system is to prevent fraud from being perpetuated on the number of insurance entities shown at 16. These insurance entities could include a number of private insurance companies 18, as well as federal insurers, such as one overseeing the workman's compensation system as shown at 20. These public insurers could include medicare, medicaid, as well as other federally-sponsored or state-sponsored programs.

The clearing house would be provided with a computer system having a memory including a list of diagnostic codes, such as ICD8, ICD9, ICD10, as well as other listing of codes prevalent in the industry. The memory included at the clearing house 12 would also include a listing of treatment codes, such as the AMA physicians Current Procedural Terminology (CPT) codes, as well as other types of treatment codes, such as the Relative Value Schedule (RVS) codes. These diagnostic and treatment codes would be provided in various databases included in the clearing house. These treatment and diagnostic codes would generally be supplied by the insurance industry. It is noted that the exact type of treatment and diagnostic codes are not crucial to the present invention. What is important is that these treatment and diagnostic codes would describe the type of treatments designated for particular illnesses and conditions. However, for purposes of the present invention, it will be assumed the CPT codes would be used for the particular treatment and ICD9 codes would be used to designate the particular illness or condition.

Prior to, during or subsequent to a patient being treated, a representative of the provider 14 would enter the appropriate CPT codes for the treatment provided, as well as the ICD9 diagnostic code. Software included on the provider's personal computer, or similar computing system, would be responsible for transmitting patient and billing data to the clearing house 12 using various standard communication links, such as, but not limited to, radio frequency communication, dedicated lines or the Internet. The software included in the provider's computer system would additional do a basic data check to insure that the billing and other information has been entered correctly. This information would also include information relating to the provider, such as a provider code and a provider license number. This is particularly important if a number of medical personnel operate at a single provider location.

The clearing house 12 would be provided with software having the ability to communicate with each of the providers 14, as well as the various insurance entities 16. Similar to the communications link between the providers 14 and the clearing house 12, communications between the clearing house 12 and the various insurance entities 16 would be by various communication means standard in the industry, such as, but not limited to, radio frequency communication, dedicated lines and the Internet.

Many of the treatments practiced by each of the providers would only be allowed if pre-approved by the various insurance entities. If this is the case, a pre-authorization or approval code would be transmitted from the insurance entities 16 to the clearing house 12, as well as the provider 14. Generally, the communication between the insurance companies 16, regarding this pre-approval, would be electronic in nature. Although communication between the insurance companies 16 and the provider 14, relating to this pre-approval, could also be electronic, the communication might include a standard pre-authorized format generated by the insurance companies and hand delivered to the provider 14 by a patient. This pre-authorization code would be compared to information sent to the clearing house 12 by the provider 14. In this manner, the clearing house would then determine that the treatment indicated by the provider 14 for a particular patient was indeed authorized at 22. The software provided at the clearing house 12 would also allow the clearing house to determine whether the CPT code was appropriate for a particular ICD9 code, as well as determining whether a plurality of CPT codes for a particular patient are mutually exclusive. This determination would be made at 24.

The clearing house would also have the ability to determine whether a provider was properly billing a particular insurance entity for various treatments or whether fraudulent multiple billing procedures were practiced at 26. Any non-adherence to the medical insurance industry's practice for one of the providers 14 would be transmitted to the appropriate insurance entity. Obviously, if fraudulent billing procedures were discovered, the provider would not be paid for these services. However, if the software at the clearing house indicates that the provider has passed the verification process, this data would also be sent to the particular insurance entity for payment. The clearing house would notify the provider that it passed the verification process and the provider would be timely paid within perhaps one, two or three days, as shown at 28. The clearing house 12 would then be compensated by the appropriate insurance entity. Although virtually any operating program could be utilized, the present system is designed to run in Windows operating systems 95, 98, ME, 2000 and XP. The system would be able to generate various types of daily, weekly and monthly reports which include a billing history and transaction codes with status, as well as the automated entry of billing information. Billing receipts would be generated in a timely manner and basic input rules would be utilized to prevent inaccurate billing before transmittal. As indicated hereinabove, various types of communication standard in the industry would be utilized between the provider 14, the clearing house 12 and the various insurance entities 16, such as the Internet or direct dial 800 numbers.

The software utilized by the present invention could be a self-contained software program in which all billing information is keyed and transmitted. This approach would require all the interfaces for patient and billing information. The system could be used in an office in which no existing software product is included and would therefore require no coordination with existing software providers.

A second approach would be designing a basic add-on system or specification so existing medical practice software providers can develop the software add-on themselves. Since the medical providers would be in possession of some existing software, this add-on system might benefit from greater levels of acceptance. Additionally, the add-on system would not require duplicate keying of data because information is exported from the system. Support/product responsibility is aimed at a data center only and not at provider offices. Office personnel would require little training because existing software would be used.

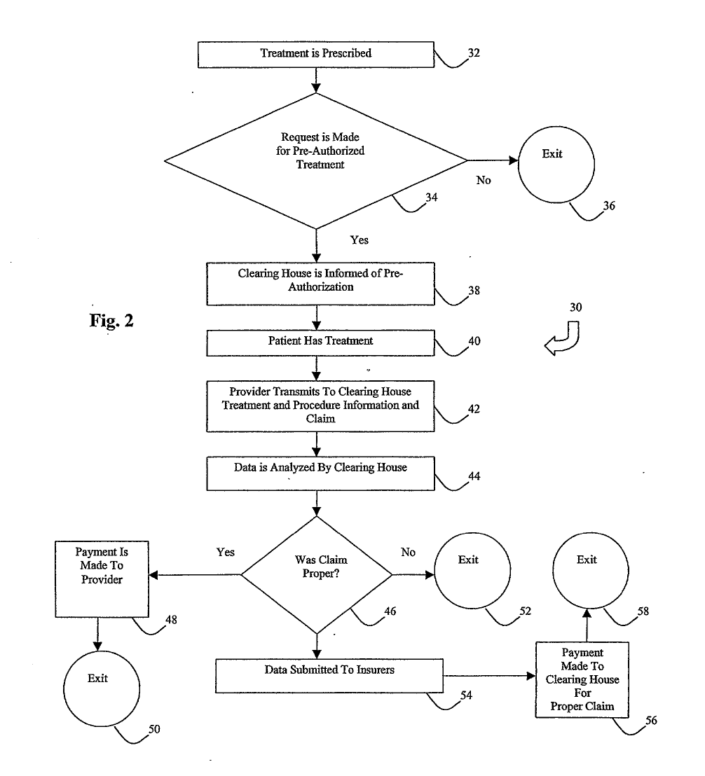

A method 30 utilizing the system shown in FIG. 1 is illustrated in FIG. 2. Initially, a particular treatment would be prescribed 32 based upon the existence of a certain condition or diagnosis by the appropriate medical personnel. Since the majority of all treatments must be pre-authorized, a request is made at 34 for such a pre-authorization from the appropriate insurance entity. If this request is denied, no further action is necessary and an exit is made from the program at 36. If the request is granted, the appropriate insurance entity 16 would inform the clearing house at 38 of this pre-authorization. As previously discussed, the provider would also be informed of the pre-authorization. Therefore, prior to, during or after the patient has received treatment at step 40, the provider would transmit to the clearing house appropriate data relating to this treatment at step 42. This data would include a provider code, a provider license number, the proper ICD9 diagnostic code, as well as the proper pre-authorized CPT code. This information would include data relating to the particular individual who conducted the treatment. This data is analyzed by the clearing house at step 44 to determine whether the claim was proper at step 46. If the claim was proper, payment would be made to the provider at step 48 from the clearing house 12 and the program would exit at step 50. If the claim was deemed not to be proper, the program would exit at step 52 and no payment would be made to the provider. In either instance, data would then be submitted to the proper insurance entity at step 54. If the claim was proper, payment, at step 56, would be made to the clearing house and the program would exit at step 58. Similarly, if the claim was deemed to be improper at step 46, the proper insurance entity would be informed of this situation. Presumably, the provider would also be informed of the non-allowance of a particular claim.

The present invention envisions a system in which data is entered and analyzed in various manners. In a first embodiment, each of the medical providers would be provided with a credit-type card, including a bar code thereon. The provider's computer system would include a reader for reading this bar code. This reader could take the form of a card swipe reader, wand reader or a similar device for entering bar code information into the computer system. The appropriate CPT, as well as ICD9, codes can be entered into the system by reading the appropriate bar code from a card or similar device including all of the treatment and diagnostic codes thereon. The provider would also indicate the time period in which the particular treatment was administered. Alternatively, information can be keyed into the system utilizing a standard keyboard or similar device for entering the appropriate information therein. Information relating to the treatment and the provider would be entered contemporaneously with the treatment being administered.

Instead of entering the information at the time the treatment was administered, the provider may choose to enter all the information for a particular for a particular day, including the provider's identification number, the identification number of each of the patients, as well as the diagnostic and treatment codes associated with each of the treatments at the end of the day. This information could be keyed into the system utilizing either of the two entry systems described hereinabove.

The clearing house 12 will then analyze the data to determine whether any fraudulent or inappropriate billing information was submitted. For example, software provided in the clearing house 12 could be used to calculate the amount of treatment time submitted by each particular provider/technician. If a particular provider/technician billed out more treatment hours than was possible, the appropriate insurance entities would be notified. Additionally, this software would have the ability to determine whether a particular treatment code corresponds with the associated diagnosis or treatment request. If this occurs, the appropriate insurance entity would be notified and payment would be denied to the provider. Furthermore, the software according to the present invention would be able to determine whether mutually exclusive treatment codes were submitted for the same patient. If this was the case, payment would also be denied to the provider.

Additionally, since the clearing house would monitor claims made by a single provider to a number of different insurance entities, the present invention would be able to determine whether a single provider claimed treatment for more than one patient during a single time period. If this situation occurred, particularly if this information was transmitted from the provider to the clearing house during the same day, payment would be denied to the provider for all claims made during a specific period of time and the appropriate insurance entities would be notified. Finally, if the provider made a claim for a particular period of time and received payment for a treatment during that time, any subsequent claim for that particular period of time would then be denied by the clearing house 12 and the appropriate insurance entity would then be notified.

Having described the preferred embodiments of the present invention, it is believed that other modifications, variations and changes will be suggested to those skilled in the art in view of the description set forth above. It is therefore to be understood that all such modification, variations and changes are believed to fall within the scope of the invention as defined in the appended claims.

We claim:

1. A system for reviewing medical treatment claims provided by a plurality of practitioners to a plurality of insurance entities for the determination of the appropriateness of the medical treatment claims, comprising:
a clearing house for receiving information from the plurality of practitioners regarding claims to be paid by one or more of the plurality of insurance entities, said clearing house provided with software to determine the appropriateness of each of the claims submitted by each of the plurality of practitioners, said clearing house communicating with the plurality of insurance entities and the plurality of practitioners regarding the appropriateness of each of the claims.

2. The system in accordance with claim 1, wherein said clearing house pays the proper practitioner once said clearing house has determined that a particular claim submitted by that practitioner to said clearing house is appropriate.

3. The system in accordance with claim 1, wherein said software determines the appropriateness of each of the claims based upon whether one of the practitioners has submitted more than one treatment claim for a single treatment period of time.

4. The system in accordance with claim 1, wherein said software determines the appropriateness of each of the claims based upon the total number of claim hours submitted by one of the practitioners for a particular duration of time.

5. The system in accordance with claim 4, wherein said particular duration of time is one work day.

6. The system in accordance with claim 1, wherein said clearing house is provided with a memory containing a list of treatment codes and a list of diagnostic codes.

7. The system in accordance with claim 6, wherein said clearing house determines the appropriateness of each claim based reviewing a treatment code with respect to a diagnostic code for a particular patient.

8. The system in accordance with claim 6, wherein said clearing house determines the appropriateness of each claim based upon a determination that a plurality of said treatment codes are mutually exclusive.

9. The system in accordance with claim 2, wherein said clearing house is paid by the appropriate insurance entity when said clearing house pays the proper practitioner.

10. The system in accordance with claim 1, further including a device for entering data provided at each of the practitioner locations.

11. The system in accordance with claim 10, wherein said device includes a bar code reader.

12. The system in accordance with claim 10, wherein said device includes a keyboard.

13. A method of determining the appropriateness of a treatment claim submitted by one of a plurality of practitioners to one of a plurality of insurance entities, the claimed treatment claim covering a treatment prescribed to a patient based upon a particular diagnosis or condition, comprising the steps of:
establishing a clearing house for examining each of the treatment claims;
submitting one or more treatment claims to said clearing house;
reviewing each of the treatment claims to determine the appropriateness of each of the treatments; and
communicating with the appropriate practitioner and the appropriate insurance entity the appropriateness of each of said treatment claims.

14. The method in accordance with claim 13, including the step of having said clearing house pay the practitioner if said reviewing step indicates that a particular submitted treatment claim was appropriate.

15. The method in accordance with claim 14, including the step of having one of the insurance entities pay said clearing house if said reviewing step indicates that a particular submitted treatment claim was appropriate.

16. The method in accordance with claim 13, wherein said reviewing step determines whether one of the practitioners has submitted more than one treatment claim for a single treatment period of time.

17. The method in accordance with claim 13, wherein said reviewing step determines the appropriateness of each treatment claim based upon the total number of claim hours submitted for a particular duration of time.

18. The method in accordance with claim 17, wherein said duration of time is a work day.

19. The method in accordance with claim 13, wherein said reviewing step includes comparing a treatment code included in said treatment claim with a diagnosis code included in said treatment claim.

20. The method in accordance with claim 13, wherein said reviewing step includes comparing more than one treatment code included in said treatment claim with one another.

21. The method in accordance with claim 13, further including the step of obtaining a pre-authorization from one of th insurance entities for the treatment covered by said treatment claim.
